(19) United States
(12) Patent Application Publication
(10) Pub. No.: US 2021/0388518 A1
(43) Pub. Date: Dec. 16, 2021

(54) IRON ALLOY WIRE COATINGS FOR WIRELESS RECHARGING DEVICES AND RELATED METHODS

(71) Applicant: Xtalic Corporation, Marlborough, MA (US)

(72) Inventors: John Cahalen, Arlington, MA (US); Stephen G. Lucas, Port Charlotte, FL (US); Robert D. Hilty, Walpole, MA (US)

(73) Assignee: Xtalic Corporation, Marlborough, MA (US)

(21) Appl. No.: 17/232,787

(22) Filed: Apr. 16, 2021

Related U.S. Application Data
(60) Provisional application No. 63/011,865, filed on Apr. 17, 2020.

(51) Int. Cl. C25D 3/20; C22C 38/08; C22F 1/08; C25D 5/50; C25D 7/06

(52) U.S. Cl. CPC C25D 3/20; C22C 38/08; C25D 7/0607; C25D 5/50; C22F 1/08

(57) ABSTRACT

Articles and methods for depositing iron alloy coatings onto metal wires for wireless recharging devices are generally described.

### RELATED APPLICATIONS

This application claims priority to U.S. Provisional Patent Application Ser. No. 63/011,865, filed Apr. 17, 2020, which is incorporated herein by reference in its entirety.

### TECHNICAL FIELD

Articles and methods for depositing iron alloy coatings onto metal wires for wireless recharging devices are generally described.

### BACKGROUND

Wireless charging coils, like those found on mobile phones, can provide quick and easy charging. However, these charging systems can have poor efficiency and slow charging. Inductive coupling between the transmit and receive coils may be improved by modifying the wire used to fabricate these coils.

### SUMMARY

Articles and methods to fabricate wireless charging coil materials with improved inductance are generally described. A wire (e.g., a copper wire) can have a metallic layer (e.g., a coating) of an iron alloy (e.g., an iron-nickel layer, an iron-nickel-cobalt layer) disposed on the wire. The metallic layer can improve the inductance of the wire when compared to a wire of the same material but absent the metallic iron alloy layer. In some embodiments, a method of electroplating a metallic layer (e.g., an iron alloy metallic layer) onto a metal (e.g., copper) wire to form a coil with improved inductance relative to the metal wire absent the metallic layer. The subject matter of the present invention involves, in some cases, interrelated products, alternative solutions to a particular problem, and/or a plurality of different uses of one or more systems and/or articles.

In one aspect, an article, comprising a wire and a metallic layer comprising an iron alloy disposed on the wire is described.

In another aspect, a method of fabricating a coil for a wireless recharging apparatus is described, the method comprising providing a wire of a first diameter to an electrodeposition bath; electroplating a metallic layer comprising an iron alloy on the wire; and winding the wire to form the coil.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1B show schematic views of a coated wire where the coated wire is a wire with a deposited metallic layer disposed on a wire, according to some embodiments;

FIG. 1C is a schematic of a coated wire with an additional layer adjacent to the metallic layer, according to certain embodiments;

FIG. 2 is a schematic illustration of a coated wire being wound or coiled to form a coil, according to some embodiments;

FIGS. 3A-3B are schematic diagrams of a wire drawer reducing the diameter of a coated wire from a first diameter to a second diameter, according to some embodiments;

FIG. 4 shows photographic images of coil test method fixtures, according to some embodiments;

FIG. 5 is a plot showing resistances of copper wire using the straight wire method at two frequencies and in direct current mode, according to one set of embodiments;

FIG. 6 shows the inductance of bare copper wire using the coil method at two frequencies, according to one set of embodiments;

FIG. 7 are plots of straight wire and coiled wire test method results for Fe—Ni20 coated wire at various frequencies, according to one set of embodiments; and

FIG. 8 are plots of the coiled wire test method results for Fe—Ni—Co alloy coated 83 μm wire at different frequencies and thicknesses, according to one set of embodiments.

### DETAILED DESCRIPTION

The present disclosure describes articles and methods related to a wire (e.g., a metal wire, a copper wire) coated with a metallic layer comprising an iron alloy (e.g., an iron-nickel alloy, an iron-nickel-cobalt alloy). Articles can be the wire or the coated wire with an iron alloy metallic layer disposed on the wire with a particular thickness. In certain embodiments, the metallic layer comprising an iron alloy can comprise additional metals, such as nickel and/or cobalt. Other metals are possible as well, which will be described below. The coated wires can have enhanced properties, such as increased inductance, when compared to uncoated coated wires (e.g., pure copper metal wires) while, in some cases, maintaining a substantially similar resistance to the uncoated wire. Accordingly, metallic layers disposed on wires may advantageously provide improved inductance when compared to certain existing systems using copper wires without a coating.

In some embodiments, a method for fabricating the coated wire is described. The method can comprise electrodepositing the metallic layer on to a wire using electrodeposition baths comprising iron compounds. The wire can have a particular diameter, which can be selected for a particular application. That is to say, in some embodiments, the method comprises providing a wire of a first diameter to an electrodeposition bath. The method can further comprise winding or coiling the wire to form a coiled wire whereby the coiled wire can be used as an induction element in wireless recharging device or another electronic device (e.g., a consumer electronic device). Additional details regarding the wire are described in more detail elsewhere herein.

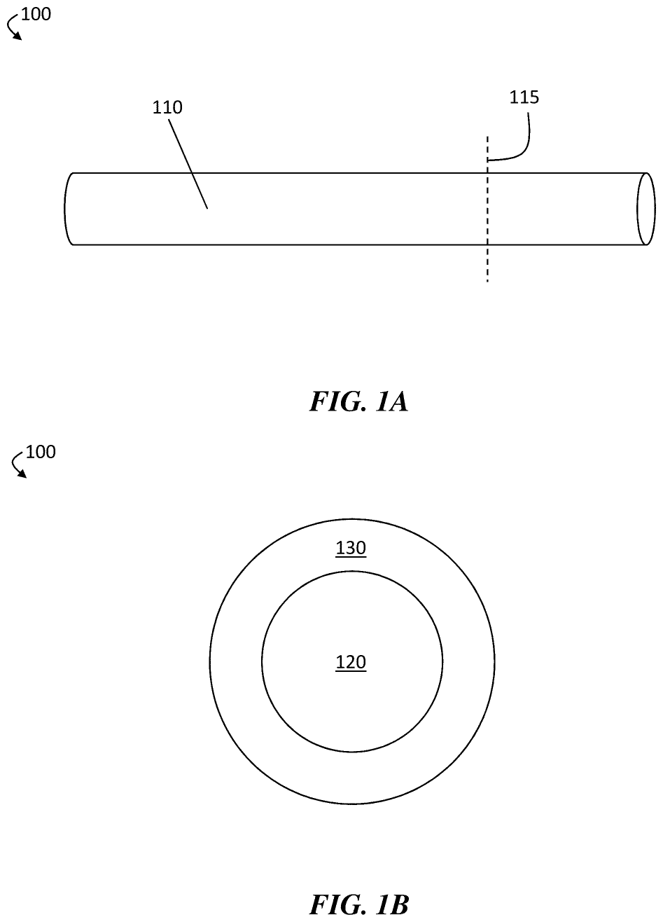

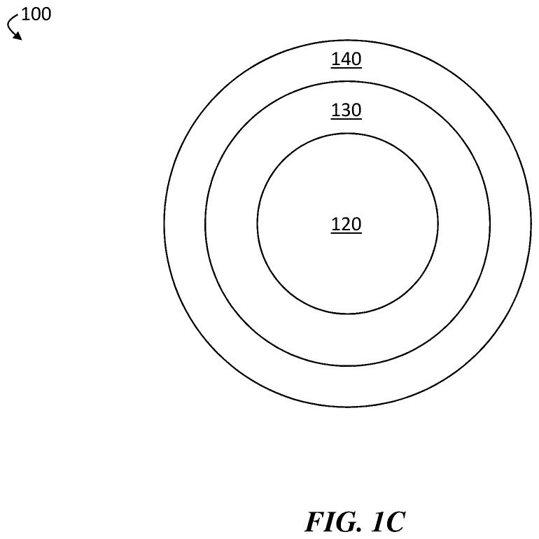

The wire (e.g., the copper wire) can have a metallic layer disposed on the wire. Referring to FIG. 1A, article 100 comprises a coated wire 110. A cross section 115 of the wire reveals a wire 120 with a metallic coating 130 disposed on wire 120, as schematically illustrated in FIG. 1B. In some embodiments, the metallic layer is an iron coating. In some embodiments, the metallic layer comprises an iron alloy. The metallic layer can be deposited by electroplating a metallic layer comprising an iron alloy on the wire. When an iron alloy is coated onto the wire, the metallic layer can comprise metals other than iron. For example, in some embodiments the metallic layer further comprises nickel (Ni), cobalt (Co), copper (Cu), magnesium (Mg), manganese (Mn), and/or zinc (Zn). For example, in some embodiments, the metallic layer is an alloy of iron and nickel. In some embodiments, the metallic layer is an alloy of iron, nickel, and cobalt. Other combinations of iron and metals are possible. In some embodiments, the article comprises at least one an additional layer (e.g., a second layer, a third layer, a fourth layer, etc.). For example, in FIG. 1C, a second layer 140 is disposed adjacent to metallic layer. These additional layers are described further elsewhere herein.

As just described, the metallic layer can comprise iron and nickel. The addition of nickel to the metallic layer comprising iron can advantageously increase the inductance of a wire (e.g., a copper wire) without significantly increasing the resistance of the copper wire.

In some embodiments, a concentration of nickel in the metallic layer is at least 2 wt %. For example, in some embodiments, the concentration of nickel in the metallic layer is at least 5 wt %, at least 10 wt % or at least 15 wt %. In some embodiments, the concentration of nickel in the metallic layer is no greater than 30 wt %, no greater than 25 wt %, or no greater than 20 wt %. Combinations of the above-referenced ranges are also possible (e.g., at least 5 wt % and no greater than 20 wt %). Other ranges are also possible. The remainder of wt % can be iron or a mixture of iron and another metal (e.g., cobalt) for a total of 100 wt % that includes nickel, iron, and any other metal present).

In some embodiments, a concentration of nickel in the metallic layer is higher than the above-noted ranges. For example, in some embodiments, the concentration of nickel in the metallic layer is at least 30 wt %, at least 35 wt %, at least 40 wt %, at least 45 wt %, at least 50 wt %, at least 55 wt %, or at least 60 wt %. In some embodiments, the concentration of nickel in the metallic layer is no greater than 60 wt %, no greater than 55 wt %, no greater than 50 wt %, no greater than 45 wt %, no greater than 40 wt %, no greater than 35 wt %, or no greater than 30 wt %. Combinations of the above-referenced ranges are also possible (e.g., at least 35 wt % and no greater than 55 wt %). Other ranges are also possible. The remainder of wt % can be iron or a mixture of iron and another metal for a total of 100 wt % that includes nickel, iron, and any other metal present).

Additional metals can be present in the iron alloy. In some embodiments, one additional metal is present in the iron alloy (e.g., nickel). In some embodiments, at least two additional metals are present in the iron alloy (e.g., nickel and cobalt). Accordingly, a particular concentration of the additional metals can be present in the metallic layer comprising the iron alloy.

In some embodiments, a concentration of cobalt, copper, magnesium manganese, and/or zinc in the metallic layer is at least 10 wt %, at least 15 wt %, at least 20 wt %, at least 25 wt %, at least 30 wt %, at least 40 wt %, at least 50 wt % or at least 60 wt %. In some embodiments, a concentration of cobalt, copper, magnesium, manganese, and/or zinc in the metallic layer no greater than 70 wt %, 60 wt %, 50 wt %, 40 wt %, 30 wt %, no greater than 25 wt %, no greater than 20 wt %, no greater than 15 wt %, or no greater than 10 wt %. Combinations of the above-referenced ranges are also possible (e.g., at least 15 wt % and no greater than 25 wt %; at least 30 wt % and no greater than 70 wt %). Other ranges are possible. In some embodiments, cobalt is a preferred additional metal.

In some embodiments, a concentration of iron in the metallic layer is the remaining wt % of any other metals (e.g., nickel, cobalt) within the metallic layer. For example, in some embodiments, a concentration of iron in the metallic layer is at least 10 wt %, 20 wt % 30 wt %, at least 40 wt %. at least 50 wt %, at least 60 wt %, at least 70 wt %, at least 80 wt %, at least 90 wt %, at least 95 wt %, at least 99 wt %, at least 99.9 wt %, or at least 99.99 wt %. In some embodiments, the entirety of the metallic layer comprises iron (i.e., the concentration of iron is 100 wt %). In some embodiments, a concentration of iron is no greater than 99.99 wt %, no greater than 99.9 wt %, no greater than 99 wt %, no greater than 95 wt %, no greater than 90 wt %, no greater than 80 wt %, no greater than 70 wt %, no greater than 60 wt %, no greater than 50 wt %, no greater than 40 wt %, no greater than 30 wt %, or no greater than 20 wt %. Combinations of the above-referenced ranges are also possible (e.g., at least 30 wt % and no greater than 65 wt %). Other ranges are possible. In cases where the entirety of the alloy is not iron, other metals can comprise the alloy, such a nickel and/or cobalt, as non-limiting examples of other metals. For example, the metallic layer coating can be an alloy of Fe and Ni with a Ni concentration of 10-25 weight percent or 35-45 weight percent, and the remaining weight percent would be 90-75 or 65-55 weight percent, respectively. In some embodiments, a ternary alloy is coated on the wire as a metallic coating with a concentration of 15-25 wt % Ni, 35-55 wt % cobalt and the balance Fe.

The metallic layer disposed on the wire can have a particular thickness. For example, in FIG. 1B, metallic layer 130 can have a particular thickness around wire 120. The thickness can be measured in microns (μm). In some embodiments, the metallic layer has a thickness of at least 0.05 microns, at least 0.1 microns, at least 0.2 microns, at least 0.5 microns, at least 1 micron, at least 2 microns, at least 5 microns, at least 7 microns, or at least 10 microns. In some embodiments, the metallic layer has a thickness of no greater than 10 microns, no greater than 7 microns, no greater than 5 microns, no greater than 2 microns, no greater than 1 micron, no greater than 0.5 microns, no greater than 0.2 microns, or no greater than 0.1 microns. Combinations of the above-referenced ranges are also possible (e.g., no greater than 5 microns and at least 0.05 microns). Other ranges are possible. It has been recognized and appreciated by this disclosure that metallic layers of such a relatively small thickness can be applied to relatively thin (e.g., small diameter) wires when compared to certain existing wires and systems. It can be difficult in conventional systems to apply coatings of a small thickness without damaging (e.g., cracking) the wire. However, as described herein, coatings can be applied and result in a coated wire free of cracks and is homogenous in coating.

The metallic layer can comprise a dopant. In some embodiments, the metallic layer comprises a dopant, the dopant comprising a rare earth metal. Examples of rare earth metals include cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), and yttrium (Y). One advantage in including a rare earth metal is to improve the magnetic properties of the metallic layer and/or the coated wire.

Some further details about the wire are now described. For example, referring back to FIGS. 1A-1C, coated wire 110 comprises wire 120. Wire is given its ordinary meaning in the art to refer to a slender, string-like piece or filament of relatively rigid or flexible metal, usually circular in section (e.g., a cross section), and can have a variety of diameters and metals depending on its application. Wires are typically electrically conductive and can comprise a single strand of metal or comprise multiple strands (e.g., two strands, three strands, four strands, five strands, or more) or metal. In such cases where a wire comprises multiple strands, the wire can be a Litz wire. A Litz wire is fabricated of individually insulated strands of metal bunched or braided together in a uniform pattern so that each strand takes all possible positions in the cross section of the overall wire.

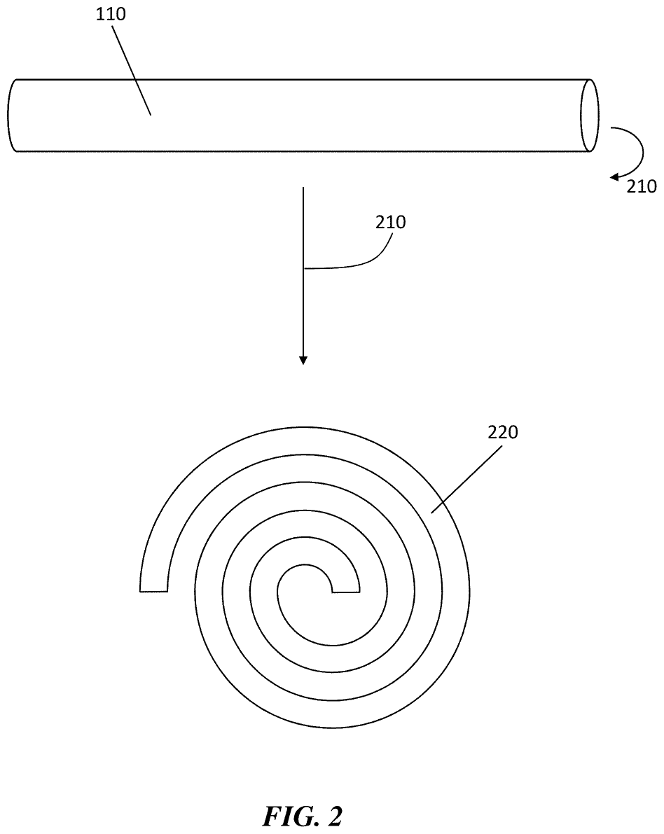

The wire can be wound or coiled. For example, in relation to FIG. 2 coated wire 110 can be turned, such as with turn 210, to undergo coiling or winding 210, which can result in coiled wire 220. However, other manipulations and arrangements of the wire are possible, such as a solenoid as one non-limiting example.

In some embodiments, the wire comprises a copper wire. However, in other embodiments, the wire comprises a metal wire different than copper. For example, the metal wire can comprise gold, silver, and/or aluminum. The wire can also be an alloy of metals (e.g., a copper alloy, a gold alloy).

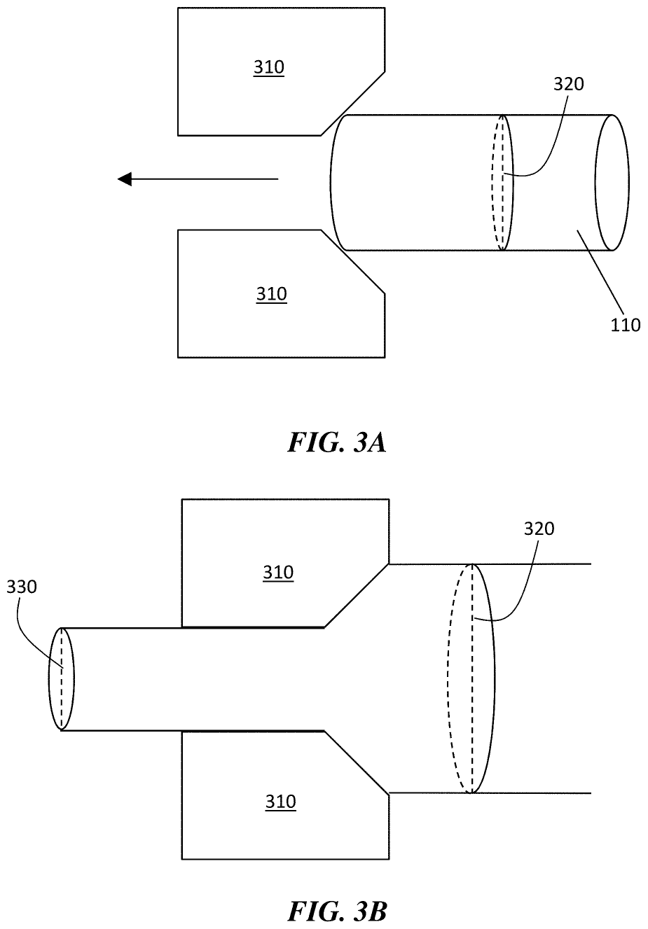

A wire (e.g., a copper wire, an uncoated wire, a coated wire) can have any suitable diameter. For example, in relation to FIG. 3A, wire 110 has a first diameter 320 in a cross section of the wire. In some embodiments, the diameter of the wire is at least 10 microns, at least 15 microns, at least 20 microns, at least 25 microns, at least 50 microns, at least 100 microns, at least 200 microns, at least 300 microns, at least 400 microns, or at least 500 microns. In some embodiments, the diameter of the wire is no greater than 500 microns, no greater than 400 microns, no greater than 300 microns, no greater than 200 microns, no greater than 100 microns, no greater than 50 microns, no greater than 25 microns, no greater than 20 microns, no greater than 15 microns, no greater than 10 microns or smaller. Combinations of the above-referenced ranges are also possible (e.g., at least 15 microns and no greater than 300 microns). Other ranges are possible.

Some embodiments can further comprise reducing the first diameter of a wire to a second diameter of a wire. Reduction in the diameter of the wire can be achieved by a variety of ways. One such way is by use of a wire drawing apparatus. Referring now to FIG. 3A and FIG. 3B, wire 110 can be drawn through a wire drawing apparatus 310, as schematically illustrated in FIG. 3A. Upon passing through wire drawing apparatus 310, first diameter 320 can be reduced to a second diameter 330 as show in the cross section in FIG. 3B. Some wires can have relatively small diameters (e.g., 30 μm), which those skilled in the art recognize can be difficult to handle on a plating line (i.e., an electroplating line) without breaking. However, as recognized by the present disclosure, a wire can be plated with a metallic layer (e.g., an iron-nickel alloy layer, an iron-nickel-cobalt layer) onto a larger diameter wire, and the wire of a first diameter can be subsequently drawn down on a wire of a second diameter by the wire drawing apparatus (e.g., drawing machine), advantageously reducing the diameter of the wire. In some embodiments, a coating is disposed on the wire, such as coated wire 110, and reducing the diameter of the wire can also reduce the thickness of the metallic layer (e.g., the coating). This advantageously allows a thicker wire (e.g., 100 μm) to be handled in the electroplating device (e.g., the plating machine) and then drawn down to the wire gauge of interest (e.g., 30 μm).

The ratio of the second diameter to the first diameter can be of a particular value or ratio. For example, in some embodiments, the ratio of the second diameter to the first diameter is at least 50%. Other ratios are possible. Accordingly, in some embodiments, the ratio of the second diameter to the first diameter is at least 10%, at least 20%, at least 30%, at least 40%, at least 50%, at least 60%, at least 70%, at least 80%, at least 90%, or at least 95%. As an illustrative hypothetical example, if the first diameter of the wire is 100 μm and is reduce to second diameter of 30 μm, then the ratio of the second diameter to the first diameter after reducing the first diameter would be 30%.

The wire (e.g., the copper wire) can be annealed. For example, the method can further comprise annealing the wire. Annealing (e.g., an annealing process) can be accomplished by heating the wire (e.g., the coated wire) and allowing the wire to slowly cool. However, other methods of annealing are possible, such as chemical annealing or plasma annealing, as non-limiting examples. Advantageously, annealing the wire after the diameter has been reduced (e.g., by a wire drawing process) can restore ductility to the wire.

In some embodiments, an additional layer can be disposed adjacent to a wire or a metallic layer (e.g., a coating). In some embodiments, the additional layer can be an additional metallic layer (e.g., a second metallic layer, a third metallic layer, fourth metallic layer, a fifth metallic layer, etc.). The properties of these additional metallic layers can be of the same properties described for the metallic layer above and elsewhere herein. In some embodiments, the additional metallic layers can be different than the metallic layers described above and elsewhere herein.

In some embodiments, the coated wire further comprises a dielectric layer and/or an adhesive layer as the additional layer. A dielectric layer is a layer comprising a dielectric material. Dielectric material will be understood to have its ordinary meaning in the art to refer to a material that is an electrical insulator that can be polarized by an applied electric field. Non-limiting examples of dielectric materials include ceramics (e.g., porcelain, silicates), glass, plastics, and oxides of various metals (e.g., iron oxides, aluminum oxides). The additional layers can comprise an adhesive layer, which can be used to bind layers together, or can be advantageous in winding or coiling the wire. Non-limiting examples of adhesive layers include glues, epoxies, and polymer adhesives.

In certain embodiments a layer (e.g., a metallic layer, an additional layer) formed on the metal wire may have a nanocrystalline microstructure. As used herein, a “nanocrystalline” structure refers to a structure in which the number-average size of crystalline grains is less than one micron. The number-average size of the crystalline grains provides equal statistical weight to each grain and is calculated as the sum of all spherical equivalent grain diameters divided by the total number of grains in a representative volume of the body. Without wishing to be bound by theory, layers formed with a nanocrystalline microstructures may comprise nanoscale grains that provide improved magnetic properties and/or improved wireless charging. Some embodiments may have a layered formed with an amorphous structure. As known in the art, an amorphous structure is a non-crystalline structure characterized by having no long range symmetry in the atomic positions. Examples of amorphous structures include glass, or glass-like structures.

Electrodeposition can be used to form a layer (e.g., a metallic layer, an iron alloy) or layers onto a wire. Electrodeposition generally involves the deposition of a material (e.g., electroplate) on a substrate (e.g., a metal wire as a substrate) by contacting the substrate with an electrodeposition bath and flowing electrical current between two electrodes through the electrodeposition bath, i.e., due to a difference in electrical potential between the two electrodes. For example, methods described herein may involve providing an anode, a cathode, an electrodeposition bath (also known as an electrodeposition fluid) associated with (e.g., in contact with) the anode and cathode, and a power supply connected to the anode and cathode. In some cases, the power supply may be driven to generate a waveform for producing a layer, as described more fully below.

Generally, a layer (e.g., a metallic layer, an iron alloy, an additional layer) may be applied using separate electrodeposition baths. In some cases, individual articles may be connected such that they can be sequentially exposed to separate electrodeposition baths, for example in a reel-to-reel process. For instance, articles may be connected to a common conductive substrate (e.g., a strip). In some embodiments, each of the electrodeposition baths may be associated with separate anodes and the interconnected individual articles may be commonly connected to a cathode.

A variety of electrochemical baths may be used for electrodeposition process. In certain embodiments an electrochemical bath contains at least an iron ionic species. The oxidation state of the iron ionic species may be 2, 3, or any other oxidation state available to iron in its compounds. In certain embodiments, other metals may be present. Those metals may be selected from the group consisting of cobalt, copper, magnesium, manganese, nickel, and zinc. Other metals may be suitable. In general, metal salts of Fe, Co, Cu, Mg, Mn, Ni, or Zn may be used as the sources of the metallic species. For example, these salts may be metal chlorides (e.g. FeCl₃), metal bromides, metal sulfates, metal nitrates, metal phosphates. Other metal salts or molecular species may be suitable as the disclosure is not so limited. Those of ordinary skill in the art will be able to determine other appropriate metal salt for electrodeposition.

Certain embodiments use an electrodeposition bath that may contain at least one component that does not contain a metal species, but may further aid in the electrodeposition process. Non-limiting examples of these components include citric acid (and salts thereof), tartaric acid (and salts thereof), acetic acid (and salts thereof), formic acid (and salts thereof), oxalic acid (and salts thereof), boric acid, saccharin, sodium chloride, sodium bromide, ammonium chloride, aluminum sulfate (or a hydrate thereof), alkali phosphates (e.g. Na₃PO₄), and non-ionic surfactants. These components may be useful in complexing metal species in solution, adjusting or buffering the pH of the electrodeposition bath, or other useful purposes. In some embodiments, other ligands or complexing agents may be present. In some embodiments, stress-reducing compounds may comprise the electrodeposition bath. In certain embodiments, a buffering agent may further comprise the electrodeposition bath. In certain embodiments, conducting salts may further comprise the electrodeposition bath. Other components may comprise the bath depending on the desired composition of the ferrite layer or the metal oxide layer. In some cases, the electrodeposition bath may further comprise a component that controls the pH, for example, to control the formation of iron hydroxides or Fe³⁺ in the electrodeposition bath or in resulting articles. Broadly, the pH may be maintained between 2-5. In some cases, the pH is kept below 7 to discourage formation of Fe(III). In some embodiments, the pH is kept below 3.5 in order to discourage iron hydroxide formation.

The electrodeposition process or processes may be modulated by varying the potential that is applied between the electrodes (e.g., potential control or voltage control), or by varying the current or current density that is allowed to flow (e.g., current or current density control). In some embodiments, the layer may be formed (e.g., electrodeposited) using direct current (DC) plating, pulsed current plating, reverse pulse current plating, or combinations thereof. In some embodiments, reverse pulse plating may be preferred, for example, to form the barrier layer (e.g., nickel-tungsten alloy). Pulses, oscillations, and/or other variations in voltage, potential, current, and/or current density, may also be incorporated during the electrodeposition process, as described more fully below. For example, pulses of controlled voltage may be alternated with pulses of controlled current or current density. In general, during an electrodeposition process an electrical potential may exist on the substrate (e.g., base material) to be coated, and changes in applied voltage, current, or current density may result in changes to the electrical potential on the substrate. In some cases, the electrodeposition process may include the use waveforms comprising one or more segments, wherein each segment involves a particular set of electrodeposition conditions (e.g., current density, current duration, electrodeposition bath temperature, etc.), as described more fully below.

Some embodiments involve electrodeposition methods wherein the grain size of electrodeposited materials (e.g., metals, alloys, and the like) may be controlled. In some embodiments, selection of a particular coating (e.g., electroplate) composition, such as the composition of an alloy deposit, may provide a coating having a desired grain size. In some embodiments, electrodeposition methods (e.g., electrodeposition conditions) described herein may be selected to produce a particular composition, thereby controlling the grain size of the deposited material.

In some embodiments, a metallic layer (e.g., an iron alloy, a coating), or portion thereof, may be electrodeposited using direct current (DC) plating. For example, a substrate (e.g., electrode) may be positioned in contact with (e.g., immersed within) an electrodeposition bath comprising one or more species to be deposited on the substrate. A constant, steady electrical current may be passed through the electrodeposition bath to produce a coating, or portion thereof, on the substrate. In some embodiments, the potential that is applied between the electrodes (e.g., potential control or voltage control) and/or the current or current density that is allowed to flow (e.g., current or current density control) may be varied. For example, pulses, oscillations, and/or other variations in voltage, potential, current, and/or current density, may be incorporated during the electrodeposition process. In some embodiments, pulses of controlled voltage may be alternated with pulses of controlled current or current density. In some embodiments, the coating may be formed (e.g., electrodeposited) using pulsed current electrodeposition, reverse pulse current electrodeposition, or combinations thereof.

In some cases, a bipolar waveform may be used, comprising at least one forward pulse and at least one reverse pulse, i.e., a “reverse pulse sequence.” In some embodiments, the at least one reverse pulse immediately follows the at least one forward pulse. In some embodiments, the at least one forward pulse immediately follows the at least one reverse pulse. In some cases, the bipolar waveform includes multiple forward pulses and reverse pulses. Some embodiments may include a bipolar waveform comprising multiple forward pulses and reverse pulses, each pulse having a specific current density and duration. In some cases, the use of a reverse pulse sequence may allow for modulation of composition and/or grain size of the coating that is produced.

Articles (e.g., a coated wire, a coil) described herein can be used as for wireless charging devices. As described herein, wireless charging (or inductive charging, used interchangeable herein) uses an electromagnetic field to transfer energy between two objects through electromagnetic induction. This is accomplished using a receive and transmit apparatus. The transmit apparatus is typically stationary and remains plugged into a standard wall outlet contains a transmit coil. The receiving apparatus is typically the device whose battery is to be recharged (e.g., a cell phone, a smartphone, a tablet, a laptop, a consumer electronic device) and contains a receiving coil. Energy is sent through an inductive coupling to an electrical device (i.e., from the transmit coil to the receive coil), which can then use that energy to charge batteries or run the device. Inductive charging uses an induction coil (i.e., transmit coil) to create an alternating electromagnetic field from within a charging base, and a second induction coil (receive coil) in the portable device receives power from the electromagnetic field and converts it back into electric current to charge the battery. The two induction coils in proximity combine to form an electrical transformer. Greater distances between sender and receiver coils can be achieved when the inductive charging system uses resonant inductive coupling.

The following examples are intended to illustrate certain embodiments of the present invention, but do not exemplify the full scope of the invention.

### Example 1

The following example describes how wireless coils were prepared and tested for inductance and resistance. Afterwards, the preparation of a copper wire plated with an iron-nickel alloy metallic layer is described.

### Performance

Wireless charging systems can use AC power at frequencies from 100 kHz to 10 MHz. As the frequency increases the coupled currents may be affected by the skin depth of penetration of the signal into the coil. As frequencies increase, the skin depth reduces, concentrating more of the transmitted power into the surface of the wire. As such, engineering the surface to more ready capture these signals can help increase inductance of the wire and improve overall performance.

Testing on plated wire formed into a wireless charging coil shows that the inductance of the coil increases when the coating is applied and the AC resistance of the coil remains about the same. As such, the ratio of inductance to AC resistance increases which can be beneficial and advantageous to charging performance.

Performance of the coil is evaluated using either a straight wire method or a coil method. For the straight wire method, a 1 m length of wire is placed on a dielectric layer and the resistance and inductance are measured at various frequencies. For uncoated copper wire, the resistance is proportional to the inverse of π×r², where r is the radius of the wire, while inductance if proportional to natural log of (1/d), where d is the diameter of the wire. In examples herein, the resistance is reported in units of milliohms (me) and the inductance is in units of nanohenry (nH).

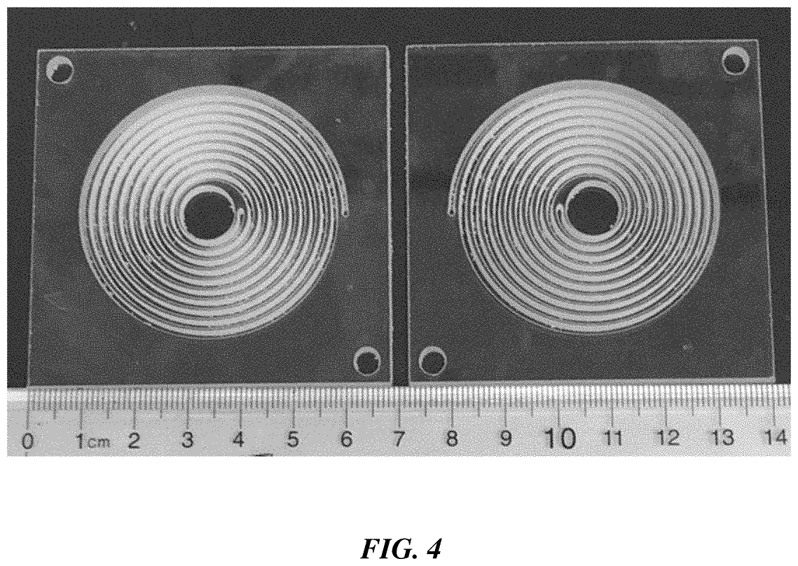

For coiled wire testing, wires of 1.2 m in length were used in two coils as shown in FIG. 4, approximately 5 cm in outer diameter and with 10 turns (i.e., winding the wire 10 times). The wire was placed into a dielectric holder to ensure positioning and electrical isolation. The mirror image coils are placed back to back and backed with a ferrite sheet, then tested for resistance and inductance as a function of frequency.

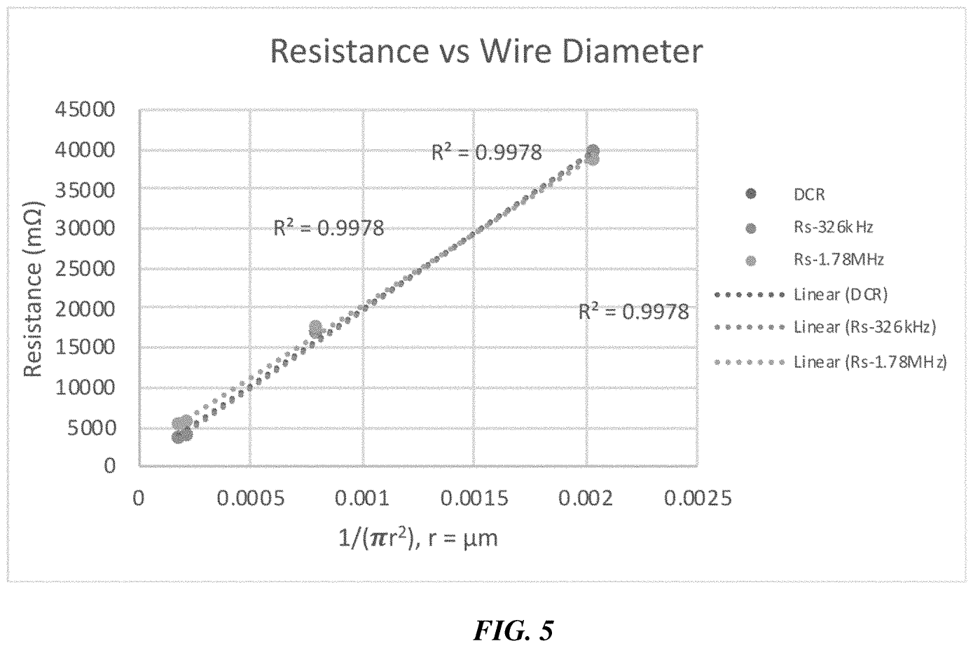

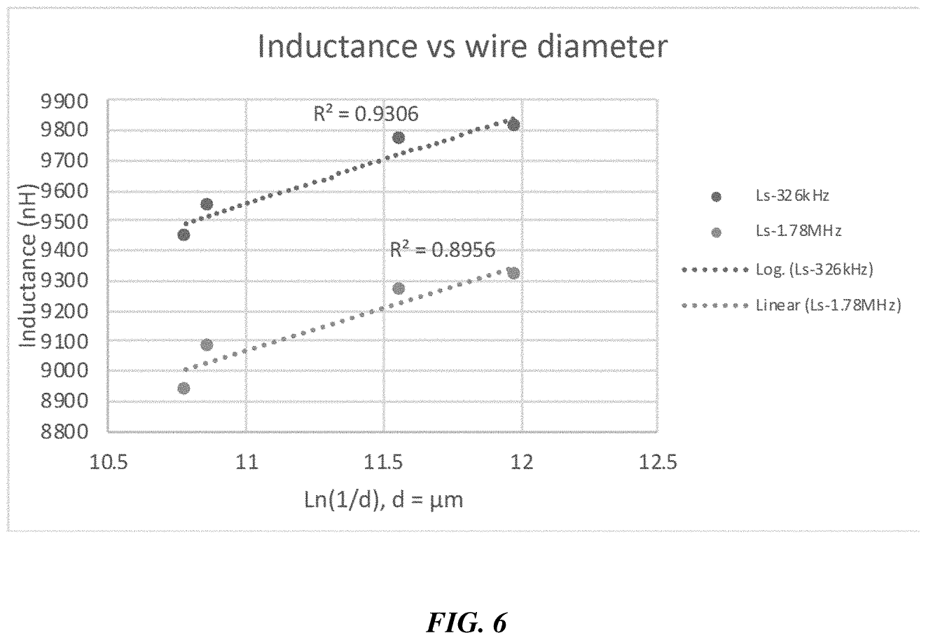

Bare copper wire is used for background test evaluation. Results from the straight wire and coiled wire test methods are shown in FIG. 5 and FIG. 6.

### Methods

The method of choice for some sampling has been roll to roll electroplating. Some of the wires are relatively small in diameter and electroplating such small diameter wires has been difficult to handle for certain existing systems without breaking. In one case the wire diameter is just 30 μm in diameter and susceptible to breaking. To avoid this issue, it was appreciated by this disclosure that a wire can plated with an iron alloy (e.g., Fe—Ni alloy metallic layer, or other alloys described herein,) onto a larger diameter wire. The wire was then subsequently drawn down on a wire drawing machine, reducing the diameter of the wire and reducing the thickness of the coating. This allows a thicker wire to be handled in the plating machine (e.g., 100 μm) then drawn down to the wire gage of interest (e.g., 30 μm). In some cases, after drawing, the wire can go through a brief annealing process in order to restore ductility.

Preparation of a Copper Wire Plated with an Iron-Nickel Alloy

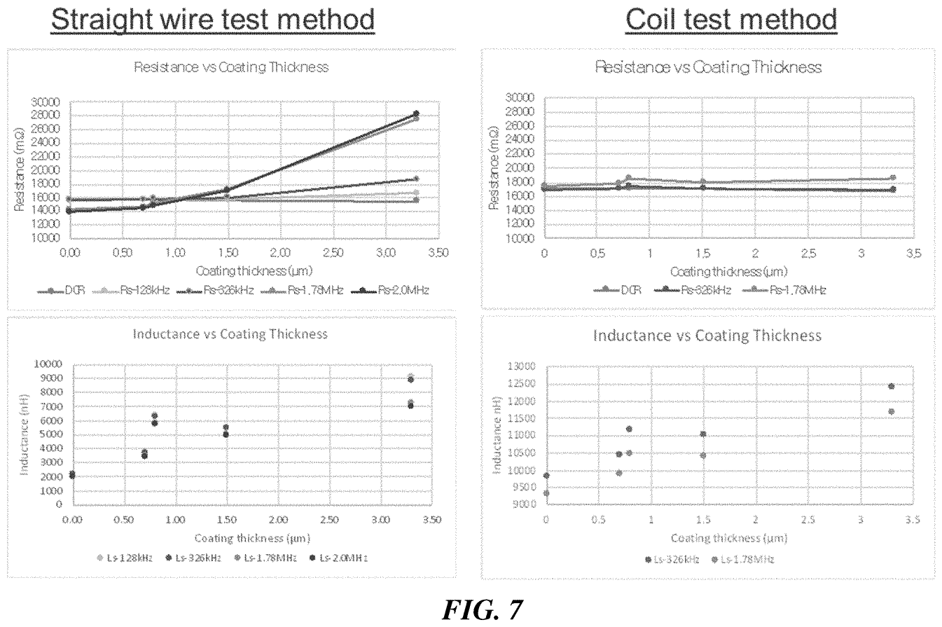

A copper wire that was 38 μm in diameter was plated with varying thicknesses of Fe—Ni alloy with a nickel content of 20 wt % as shown in FIG. 7. The resulting coated copper wire was tested using the straight wire and coiled wire test methods. It was observed that for either test method, a significant increase in inductance was seen while the resistance remained mostly unchanged. For the coil method, which more closely matches the intended use case of a wireless recharging apparatus, an unexpected 10% increase in inductance with no increase in resistance at a coating thickness of 1 μm.

### Example 2

The following example describes the preparation of a copper wire plated with an iron-nickel-cobalt ternary alloy metallic layer.

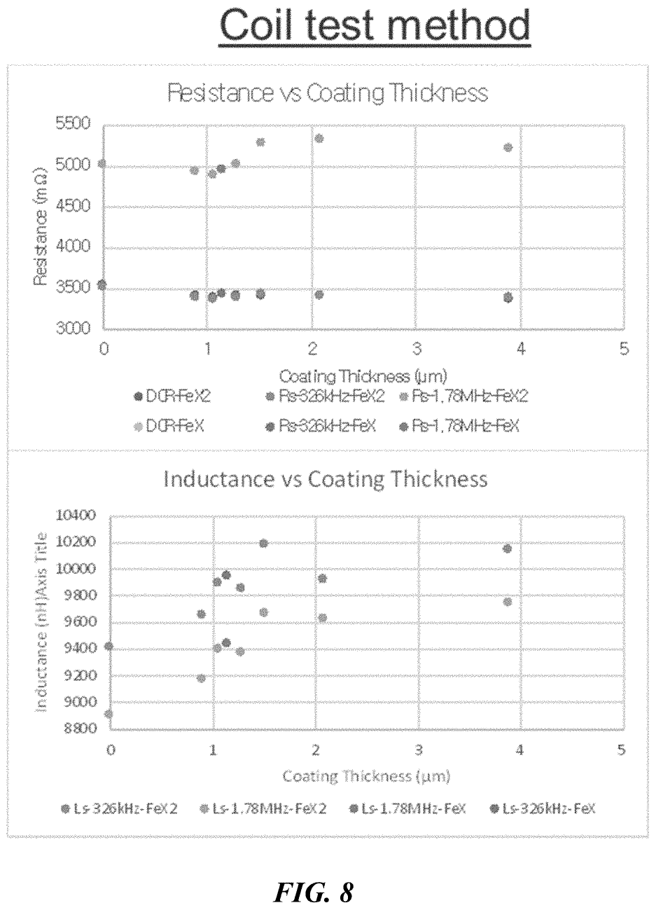

A copper wire that is 83 μm in diameter was plated with the ternary Fe—Ni—Co alloy to varying thicknesses as shown in FIG. 8. The coated wires were evaluated with the coiled wire method for inductance and resistance at various frequencies. At a coating thickness of 1 μm, an unexpected 7% increase in inductance was observed with little impact on resistance. The Fe—Ni—Co alloy showed a smooth deposit with a homogeneous microstructure.

### Example 3

The following example describes a preparation of a copper wire with iron and 20 wt % nickel as a metallic layer. The wire had its diameter reduced using a draw method.

A 76 μm diameter copper wire was coated with Fe-20Ni then mechanically drawn to a final diameter of 40 μm. The wire was flash annealed during the drawing process in order to restore ductility to the wire. The coating was crack free and homogeneous after drawing. Wires were tested using the coil test method. The resulting wire had a coating thickness of 1.4 μm as shown below in Table 1.

TABLE 1

| | Inductance | Resistance | Inductance | Resistance |
|---|---|---|---|---|
| Sample | at 326 kHz | at 326 kHz | at 1.78 MHz | at 1.78 MHz |
| Bare copper, | 9730 | 18608 | 9238 | 20291 |
| 37.2 μm | | | | |
| diameter | | | | |
| Copper + | 11097 | 18349 | 10528 | 18870 |
| coating, 40 μm | | | | |
| diameter | | | | |
| Difference | 14% | (1%) | 14% | (7%) |

### Example 4

The following example describes a preparation of a copper wire with iron and 20 wt % nickel as a metallic layer. The wire had its diameter reduced using a draw method.

A 76 μm diameter copper wire was coated with Fe-20Ni then mechanically drawn to a final diameter of 30 μm. The wire was flash annealed during the drawing process in order to restore ductility to the wire. The coating was crack free and homogeneous after drawing. Wires were tested using the coil test method. The resulting wire had a coating thickness of 1.1 μm as shown in below in Table 2.

TABLE 2

| | Inductance | Resistance | Inductance | Resistance |
|---|---|---|---|---|
| Sample | at 326 kHz | at 326 kHz | at 1.78 MHz | at 1.78 MHz |
| Bare copper, | 9816 | 33156 | 9324 | 34839 |
| 27.8 μm | | | | |
| diameter | | | | |
| Copper + | 10999 | 29231 | 10443 | 28966 |
| coating, 30 μm | | | | |
| diameter | | | | |
| Difference | 12% | (12%) | 12% | (17%) |

### Example 5

The following example describes a preparation of a copper wire with iron and 20 wt % nickel as a metallic layer. The wire had its diameter reduced using a draw method. This wire is compared to the performance of a pure copper wire absent the metallic layer.

A 76 μm diameter copper wire was coated with Fe-20Ni then mechanically drawn to a final diameter of 30 μm. The wire was flash annealed during the drawing process in order to restore ductility to the wire. The coating was crack free and homogeneous after drawing. Wires were tested using the coil test method. The resulting wire had a coating thickness of 1.1 μm. In this example was compared to the performance of a copper wire (“bare copper” in Table 3) of similar final diameter as the coated wire. While both the inductance and the resistance increase, the increase in inductance is greater than the increases in resistance, as shown below in Table 3.

TABLE 3

| | Inductance | Resistance | Inductance | Resistance |
|---|---|---|---|---|
| Sample | at 326 kHz | at 326 kHz | at 1.78 MHz | at 1.78 MHz |
| Bare copper, | 9794 | 28500 | 9301 | 30184 |
| 30 μm diameter | | | | |
| Copper + | 10999 | 29231 | 10443 | 28966 |
| coating, 30 μm | | | | |
| diameter | | | | |
| Difference | 12% | 3% | 12% | 4% |

### Example 6

The following example describes a preparation of a copper wire with iron and 20 wt % nickel as a metallic layer. The wire had its diameter reduced using a draw method. This wire is compared to the performance of a pure copper wire absent the metallic layer.

A 129 μm diameter copper wire was coated with Fe-20Ni then mechanically drawn to a final diameter of 30 μm. The wire was flash annealed during the drawing process in order to restore ductility to the wire. The coating was crack free and homogeneous after drawing. Wires were tested using the coil test method. The resulting wire had a coating thickness of 0.32 μm. In this example the performance of a bare copper wire of similar final diameter was compared to the coated wire. While both the inductance and the resistance increase, the increase in inductance is greater than the increases in resistance, as shown in Table 4.

TABLE 4

| | Inductance | Resistance | Inductance | Resistance |
|---|---|---|---|---|
| Sample | at 326 kHz | at 326 kHz | at 1.78 MHz | at 1.78 MHz |
| Bare copper, | 9794 | 28500 | 9301 | 30184 |
| 30 μm diameter | | | | |
| Copper + | 10044 | 27009 | 9551 | 26935 |
| coating, 30 μm | | | | |
| diameter | | | | |
| Difference | 3% | (5%) | 3% | (14%) |

### Example 7

The following example describes a preparation of a copper wire with iron and 20 wt % nickel as a metallic layer. The wire had its diameter reduced using a draw method. This wire is compared to the performance of a pure copper wire absent the metallic layer.

A 129 μm diameter copper wire was coated with Fe-20Ni then mechanically drawn to a final diameter of 30 μm. The wire was flash annealed during the drawing process in order to restore ductility to the wire. The coating was crack free and homogeneous after drawing. Wires were tested using the coil test method. The resulting wire had a coating thickness of 0.87 μm. In this example, the performance of a copper wire of similar final diameter was compared to the coated wire. While both the inductance and the resistance increase, the increase in inductance is greater than the increases in resistance, as shown in Table 5 below.

TABLE 5

| | Inductance | Resistance | Inductance | Resistance |
|---|---|---|---|---|
| Sample | at 326 kHz | at 326 kHz | at 1.78 MHz | at 1.78 MHz |
| Bare copper, | 9794 | 28500 | 9301 | 30184 |
| 30 μm diameter | | | | |
| Copper + | 11137 | 28374 | 10613 | 28889 |
| coating, 30 μm | | | | |
| diameter | | | | |
| Difference | 14% | (12%) | 14% | (14%) |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An article, comprising:
a wire; and
a metallic layer comprising an iron alloy disposed on the wire.

2. A method of fabricating a coil for a wireless recharging apparatus, the method comprising:
providing a wire of a first diameter to an electrodeposition bath;
electroplating a metallic layer comprising an iron alloy on the wire; and
winding the wire to form the coil.

3. The article of claim 1, wherein the iron alloy comprises nickel and/or cobalt.

4. The article of claim 1, wherein the wire comprises a metal wire.

5. The article of claim 1, wherein the wire comprises a copper wire.

6. The article of claim 1, the wire comprises a single strand.

7. The article of claim 1, wherein the wire comprises multiple strands.

8. The article of claim 1, wherein the diameter of the wire is at least 15 microns.

9. The article of claim 1, wherein the diameter of the wire is no greater than 300 microns.

10. The article of claim 1, wherein the iron alloy further comprises nickel, cobalt, copper, magnesium, manganese, and/or zinc.

11. The article of claim 1, wherein a concentration of nickel in the metallic layer is at least 10 wt %.

12. The article of claim 1, wherein a concentration of nickel in the metallic layer is no greater than 30 wt %.

13. The article of claim 1, wherein a concentration of nickel in the metallic layer is no greater than 20 wt %.

14. The article of claim 1, wherein a concentration of cobalt, copper, magnesium manganese, and/or zinc in the metallic layer is at least 30 wt %.

15. The article of claim 1, wherein a concentration of cobalt, copper, magnesium, manganese, and/or zinc in the metallic layer no greater than 60 wt %.

16. The article of claim 1, wherein a concentration of iron in the metallic layer is the remaining wt % of any other metals within the metallic layer.

17. The article of claim 1, wherein the metallic layer has a thickness of at least 0.05 microns.

18. The article of claim 1, wherein the metallic layer has a thickness of no greater than 10 microns.

19. The article of claim 1, wherein the metallic layer comprises a dopant.

20. The article of claim 1, wherein the metallic layer comprises a dopant, the dopant comprising a rare earth metal.

21. The article of claim 1, further comprising a dielectric layer and/or an adhesive layer.

22. The method of claim 1, further comprising reducing the first diameter to a second diameter.

23. The method of claim 1, wherein the ratio of the second diameter to the first diameter is at least 50%.

24. The method of claim 2, further comprising annealing the wire.
